(19) United States
(12) Patent Application Publication
(10) Pub. No.: US 2014/0127791 A1
(43) Pub. Date: May 8, 2014

(54) DIAGNOSTIC DEVICE

(71) Applicants: Stefan FOERTSCH, Kunreuth (DE); Rainer KUTH, Hoechstadt (DE); Karl-Heinz MAIER, Altdorf b. Nuernberg (DE)

(72) Inventors: Stefan FOERTSCH, Kunreuth (DE); Rainer KUTH, Hoechstadt (DE); Karl-Heinz MAIER, Altdorf b. Nuernberg (DE)

(73) Assignee: Siemens Aktiengesellschaft, Munich (DE)

(21) Appl. No.: 14/151,468

(22) Filed: Jan. 9, 2014

Related U.S. Application Data
(63) Continuation-in-part of application No. 13/146,701, filed on Jul. 28, 2011.

(51) Int. Cl. G01N 27/327

(52) U.S. Cl. CPC G01N 27/3275
USPC 435/287.1

(57) ABSTRACT

A diagnostic device as a first electrode formed by a noble metal that is not attackable by acid, and a second electrode that is formed of silver. The first and second electrodes are at least partially immersed in a nutrient solution contained in a container, into which a tissue sample can be introduced. An electrical voltage is applied between the first and second electrodes, and a change in an electrical variable between the electrodes is measured when ammonia is present. The diagnostic device allows fast screening of tissue samples for Helicobacter pylori.

### CROSS-REFERENCE TO RELATED APPLICATIONS

This application is a continuation-in-part of U.S. application Ser. No. 13/146,701 filed Jul. 28, 2011, the entire contents of which is hereby incorporated by reference herein.

### BACKGROUND OF THE INVENTION

1. Field of the Invention

The invention relates to a diagnostic device.

Such a diagnostic device serves, for example, for detecting Helicobacter pylori.

2. Description of the Prior Art

A common cause for discomforts in the upper gastrointestinal tract is a bacterial affliction of the organs therein. By way of example, an affliction with Helicobacter pylori is held responsible for a vast range of gastric disorders that go hand-in-hand with an increased secretion of gastric acid. By way of example, these include type B gastritis, approximately 75% of gastric ulcers and almost all duodenal ulcers. Hence, examining the hollow organs of the gastrointestinal tract for bacteria populations, more particularly Helicobacter pylori populations, is an important component for diagnosing gastric disorders.

For example, Helicobacter pylori is detected using a breath test, in which a patient is administered C-13 masked urea. The C-13 masked CO2, which is created when urea (CO(NH2)2) is split into ammonia (NH3) and carbon dioxide (CO2), is detected in the exhaled air. Other methods for detecting Helicobacter pylori are directed at typical blood values such as pepsinogen or gastrin. However, such methods are complex and only have limited reliability. A further test for Helicobacter pylori is the detection of the Helicobacter pylori antigen in fecal matter.

A further option for examining the stomach for a Helicobacter pylori population is provided by so-called gastroscopy. During such an examination, a gastroenterologist takes a tissue sample (biopsy specimen) from the mucosa of the stomach by means of a biopsy in order to examine, either immediately or at a later stage, whether there is an infection with Helicobacter pylori. A known examination method for the tissue sample is, for example, the Helicobacter urease test (HU test, abbreviated HUT). The biopsy specimen is placed into a test medium (measurement solution), which consists of a nutrient solution for this bacteria, urea, and an indicator (litmus). If Helicobacter pylori bacteria is contained in the sample, the bacteria splits the urea (CO(NH2)2) using urease into ammonia (NH3) and carbon dioxide (CO2). The ammonia then colors the indicator red. The test result is ready after a few minutes. The onset of color change from yellow to red cannot unambiguously be identified in inexpedient conditions.

An alternative to gastroscopy carried out using a flexible endoscope is to use a so-called endoscopic capsule. Such an endoscopic capsule, which is also referred to as a capsule endoscope or endocapsule, is embodied as a passive endocapsule or a navigable endocapsule. A passive endoscopic capsule moves through the intestines of the patient as a result of peristalsis.

For example, a navigable endocapsule is known from DE 101 42 253 C1 and the corresponding patent application with the publication number US 2003/0060702 A1, and therein it is referred to as an “Endoroboter” or “endo-robot”. The endo-robot known from these publications can be navigated in a hollow organ (e.g. gastrointestinal tract) of a patient by means of a magnetic field, which is generated by an external (i.e. arranged outside of the patient) magnetic system (coil system). An integrated system for controlling the position, which comprises a positional measurement of the endo-robot and automatic regulation of the magnetic field or the coil currents, can be used to detect changes automatically in the position of the endo-robot in the hollow organ of the patient and to compensate for these. Furthermore, the endo-robot can be navigated to desired regions of the hollow organ in a targeted fashion. It is for this reason that this type of capsule endoscopy is also referred to as magnetically guided capsule endoscopy (MGCE).

### SUMMARY OF THE INVENTION

An object of the present invention is to provide a diagnostic device that can be used to test a fresh tissue sample for Helicobacter pylori within a very short period of time.

The diagnostic device according to the invention has a first electrode (reference electrode) made of a noble metal, which cannot be attacked by acid (e.g. hydrochloric acid, phosphoric acid, sulfuric acid, gastric acid), and a second electrode (measurement electrode) made of silver. The first electrode and the second electrode are at least partially immersed in a container that is filled with a nutrient solution (measurement solution) and into which a tissue sample can be introduced. An electric voltage can be applied between the first electrode and the second electrode, and a change in an electrical variable can be measured if ammonia is present between the first electrode and the second electrode.

In a preferred version of the diagnostic device according to the invention, the electric voltage between the first electrode and the second electrode equals zero. Thus no current flows between the first electrode and the second electrode. The potential thus is measured (i.e. without a current) between the first electrode and the second electrode. Thus there is barely any ionic migration in the acidic nutrient solution. In a further advantageous embodiment, the electric voltage between the first electrode and the second electrode is an AC voltage with a variably predeterminable frequency spectrum. If nutrient solution is exposed to direct current or a directed potential the ions migrate to the associated electrodes, i.e. the cations (e.g. ammonium NH4+) migrate to the cathode and the anions (e.g. chloride Cl—) migrate to the anode. By applying a suitable AC voltage, the diagnostic device reliably prevents complete charging of the first electrode (reference electrode) and complete charging of the second electrode (measurement electrode) because the migration speed of the ions in the acidic nutrient solution (measurement solution) is almost zero if the frequency is sufficiently high.

When an AC voltage is applied, there is a cyclical change at the second electrode (measurement electrode), which, according to the invention, consists of silver (Ag), between destruction and buildup of the silver chloride (AgCl) layer. Both the destruction of the silver chloride layer and the buildup thereof can be measured by e.g. an impedance measurement and can be compared cyclically. The potential differences and phase differences that can be measured in the process are characteristic for the presence of urease activity, as a result of which presence of Helicobacter pylori can be deduced with a very high certainty.

In a further embodiment, the frequency spectrum of the AC voltage is modulated. As a result, a higher AC voltage stability is obtained, which increases the measurement accuracy and reduces the measurement duration.

Alternatively, the electric voltage between the first electrode and the second electrode is a DC voltage, which can be applied for a predeterminable period of time. The predeterminable period of time during which an electric voltage can be applied by the user between the first electrode and the second electrode may lie between zero seconds and continuously, wherein the electric voltage selected by the user may be zero volts or higher. In the case of a period of time of zero seconds or a voltage of zero volts, this is a passive measurement. In the case of values deviating from these, this is an active measurement.

In further embodiments of the diagnostic device according to the invention, e.g. potentials, electric currents or electric resistances or the changes therein or variables (e.g. electric conductivity) derived from the electrical variables or changes therein can be measured as electrical variables.

The second electrode (measurement electrode), which consists of silver (Ag) in diagnostic device according to the invention, must be etched (roughened) by hydrochloric acid (HCl). This may (but this is not necessary) already occur for the first time before the diagnostic device or the second electrode is supplied. However, it is also possible for the users themselves to undertake the initial HCl etching or apply an appropriate silver chloride layer by means of a suitable electrolytic method. After HCl etching or after electrolytic deposition, the second electrode has a silver chloride (AgCl) coating on its surface and is therefore activated for the measurement to detect Helicobacter pylori.

The diagnostic device according to the invention allows simple open or closed loop control of the sensor or its first electrode (reference electrode) and/or its second electrode (measurement electrode) e.g. by means of a baseline correction. Furthermore, a reproducible regeneration of the second electrode, i.e. removal of the damage caused by ammonia in the silver chloride layer, is possible after each examination.

If the measures outlined above are taken, the second electrode is not completely charged, and so a regeneration of the second electrode only becomes necessary after a multiplicity of examinations.

Moreover, the sensitivity of the sensor and/or its first and/or second electrode can be set in a simple fashion in the diagnostic device according to the invention. The sensitivity can be set before and during the analysis in respect of Helicobacter pylori.

Platinum (Pt) and gold (Au) can be used as noble metals that are not attacked by acid and therefore are suitable for the first electrode (reference electrode).

Preferably, the nutrient solution (measurement solution) provided is an acidic nutrient solution, more particularly a hydrochloric nutrient solution. A buffered nutrient solution is particularly preferred. According to a further preferred embodiment, the urea is added to acidic nutrient solution.

If, then, a tissue sample taken from the gastro-intestinal tract is introduced into the hydrochloric nutrient solution (pH similar to that of the stomach), then affliction of the tissue sample with Helicobacter pylori can be detected by detecting ammonia (NH3). Ammonia is generated by the Helicobacter pylori bacteria by splitting urea using urease in order to protect itself from the acidic environment of the gastrointestinal tract, more particularly the high acid concentration in the stomach.

As noted above, second electrode (measurement electrode), which consists of silver (Ag) in the diagnostic device according to the invention, must be etched by hydrochloric acid (HCl). After the HCl etching, the second electrode has a silver chloride (AgCl) coating on its surface and is therefore activated for the measurement to detect Helicobacter pylori. The activation of the second electrode is based on the following chemical reaction:

Ag+HCl→AgCl+H⁺+e⁻

Since ammonia (NH3) under normal circumstances does not occur, or only occurs in very low concentrations in a hollow organ of the gastrointestinal tract, such as the stomach, as a result of the following neutralization reaction (forming an ammonium cation by protonation of ammonia)

NH₃+H⁺ [symbol] NH₄⁺

the detection thereof is a very strong indication for the presence of Helicobacter pylori. The proton (H⁺, hydrogen nucleus) is a component of the gastric acid.

The corresponding chemical reaction for detecting Helicobacter pylori is:

AgCl+2 NH₃→[Ag(NH₃)₂]⁺+Cl⁻

The AgCl salt (silver chloride) is split into the silver-diammine complex [Ag(NH3)2]+ and chloride Cl— by ammonia. [Ag(NH3)2]+ as a cation is very soluble in water and absorbed by the nutrient solution (measurement solution). In advantageous embodiments of the diagnostic device according to the invention, there is, between the first electrode (reference electrode) and second electrode (measurement electrode), either an electric voltage of zero or an electric AC voltage with a variably predeterminable frequency spectrum. Alternatively, a DC voltage can be applied between the first electrode and the second electrode for a predeterminable period of time. In all cases, there is barely any ion migration in the nutrient solution (migration speed of the cations and anions is approximately zero).

The electrical variable (potential, electric current, electric resistance) measured between the first electrode (reference electrode) and second electrode (measurement electrode) is recorded, displayed, and—if desired—transmitted to evaluation electronics. As a result of an (automated) comparison between the measured value and predetermined values, a possible affliction of the mucosa of the stomach with Helicobacter pylori can be reliably indicated.

After the analysis of the tissue sample taken is completed, the container and the electrodes are first disinfected with a cleaning solution (e.g. ethanol or isopropanol) and subsequently rinsed with rinsing solution (hydrochloric acid or a mixture of hydrochloric acid and urea). By rinsing the second electrode (measurement electrode) with hydrochloric acid, the AgCl surface on the second electrode is regenerated. The damage to the AgCl layer of the second electrode caused by ammonia is thereby removed again. The diagnostic device according to the invention can thus once again be used for detecting Helicobacter pylori after refilling the container with a nutrient solution, preferably with an acidic nutrient solution, more particularly with a buffered nutrient solution, and after a possible necessary recalibration. By way of example, the diagnostic device can be calibrated by a dose of synthetic ammonia.

The diagnostic device according to the invention thus allows a very quick examination of tissue samples taken in respect of Helicobacter pylori.

Both the first electrode (reference electrode) and the second electrode (measurement electrode) may be embodied as separate rod-shaped or planar electrodes, which are at least in part immersed into the nutrient solution.

When the diagnostic device is used, care has to be taken that the nutrient solution at all times only wets the silver chloride layer, particularly even once the tissue sample has been introduced. However, as per an embodiment with a simple design of the diagnostic device according to the invention, the first electrode is integrated into a wall of the container or formed by a wall of the container. Additionally, or as an alternative thereto, the second electrode is formed by the base of the container as a further design simplification. A tissue sample taken from the patient can then be introduced into the nutrient solution anywhere within the container. As a result, direct positioning on the second electrode is not required.

### BRIEF DESCRIPTION OF THE DRAWINGS

The present invention is described in detail below with reference to the attached drawing figures, wherein:

FIG. 1 is a schematic cross section view of an illustration of an embodiment of a diagnostic device constructed and operating in accordance with the present invention;

FIG. 2 is a detail view of an embodiment of an evaluation unit of a diagnostic device in standby-mode ready to accept a test specimen for testing, and showing a measurement of an electrical variable;

FIG. 3 is a detail view of an embodiment of an evaluation unit of the diagnostic device of FIG. 2, showing a test specimen being tested, and displaying no change in the electrical variable as compared to the measured electrical variable in standby-mode, indicating no presence of Helicobacter pylori bacteria;

FIG. 4 is a detail view of an embodiment of an evaluation unit of the diagnostic device of FIG. 2, showing a test specimen being tested, and displaying a change in the electrical variable as compared to the measured electrical variable in standby-mode, indicating the presence of Helicobacter pylori bacteria;

FIG. 5 is a flow chart for an embodiment of a process for diagnosing the presence of Helicobacter pylori using a diagnostic device of the present disclosure.

### DESCRIPTION OF THE PREFERRED EMBODIMENTS

The invention and further advantageous embodiments are explained in more detail below in the drawings on the basis of a schematically illustrated exemplary embodiment; however, the invention is not restricted to the explained exemplary embodiment.

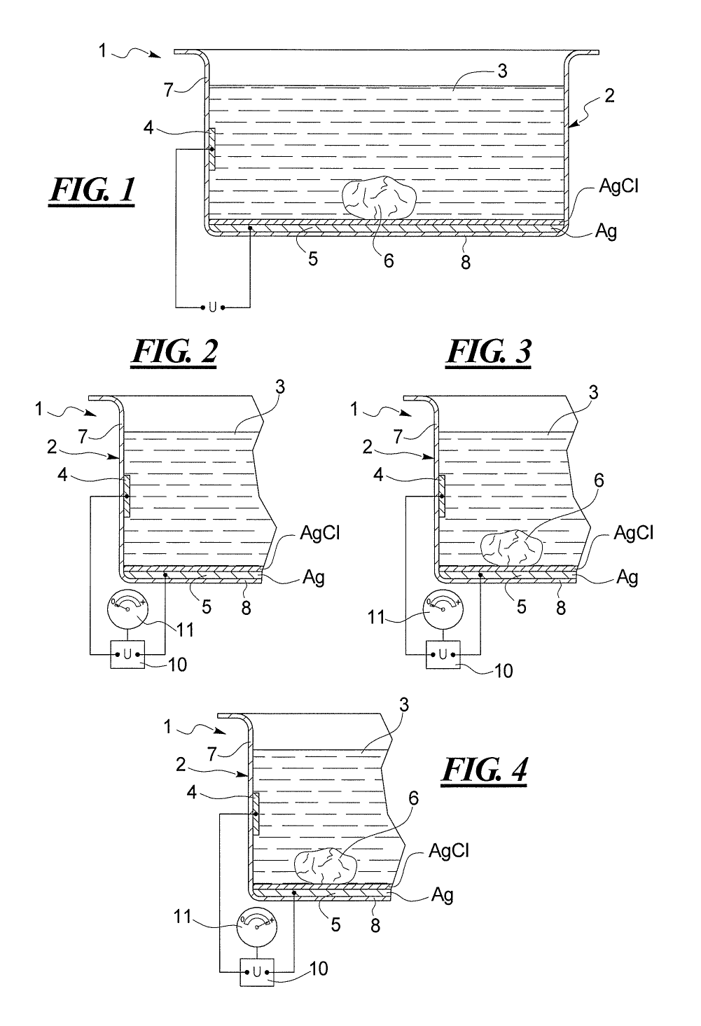

The embodiment depicted in FIG. 1 shows a diagnostic device 1, which includes a container 2 which is filled with an acidic, preferably buffered nutrient solution 3 (measurement solution). In the illustrated exemplary embodiment, urea is added to the nutrient solution 3.

In the illustrated exemplary embodiment of FIG. 1, the diagnostic device 1 has a first electrode 4 (reference electrode) made of a noble metal, which cannot be attacked by hydrochloric acid, and a second electrode 5 (measurement electrode) made of silver (Ag). The second electrode 5 has a silver chloride layer (AgCl layer) on its surface and is therefore activated for the measurement to detect Helicobacter pylori.

Platinum (Pt) and gold (Au) can be used as noble metals that are not attacked by hydrochloric acid and therefore are suitable for the first electrode 4.

The first electrode 4 and the second electrode 5 are at least partly immersed into the container 2.

A tissue sample 6 (biopsy specimen), which was taken from the mucosa of the stomach by means of a biopsy, has been introduced into the container 2 filled with the nutrient solution 3.

An electric voltage “U” can be applied between the first electrode 4 and the second electrode 5 for a predeterminable time, as a result of which a change in an electrical variable, e.g. potential, electric current, or electric resistance, can be measured if ammonia is present between the first electrode 4 and the second electrode 5.

Referring to FIG. 1, in the illustrated exemplary embodiment of the diagnostic device according to the invention, the first electrode 4 (reference electrode) is integrated into a wall 7 of the container 2 and the second electrode 5 (measurement electrode) is formed by the base 8 of the container 2. Hence, the illustrated embodiment of the diagnostic device according to the invention has a particularly simple design. The tissue sample 6 taken from the patient can then advantageously be introduced into the acidic nutrient solution 3 anywhere within the container 2. As a result, direct positioning of the tissue sample 6 on the second electrode 5 is not required.

Referring to FIG. 2, an embodiment of a diagnostic device 1 as disclosed herein is depicted in a standby-mode, wherein the container 2 is filled with a nutrient solution 3 and ready to accept a test specimen, such as a tissue sample 6 taken from a biopsy of suspicious or abnormal appearing tissue. The diagnostic device 1 includes a first electrode 4 and a second electrode 5 submerged in the nutrient solution 3, as previously disclosed herein. In the embodiment shown in FIG. 2, the first electrode 4 and second electrode 5 are disposed in a wall 7 and base 8 of the container 2 respectively, however, in other embodiments, the electrodes 4, 5 may have other configurations and be disposed elsewhere in relation to the container 2 without departing from the scope of the present disclosure.

The diagnostic device 1 further includes an evaluation unit 10 in electrical communication with each of the electrodes 4, 5. In one embodiment, the evaluation unit 10 may be a computerized apparatus containing an analysis processor and a non-transient computer readable electronic storage medium in communication with the processor. The evaluation unit may further include a results indicator (not shown) in communication with at least one of the processor and electronic storage medium that is configured to provide an indication, such as a visual or auditory indication, as to the presence or absence of a threshold amount of ammonia present in the nutrient solution between the first electrode 4 and the second electrode 5. If a predetermined threshold amount of ammonia is determined by the evaluation unit to be present in the nutrient solution when the tissue sample is introduced therein, the results indicator provides an appropriate visual or auditory indication thereof, which then indicates that an infection of Helicobacter pylori bacteria is present within a test specimen. However, in still alternate embodiments, the diagnostic device 1 may be connected to and/or in communication with a separate stand-alone computer system (not shown) that includes a processor, a computer readable electronic storage medium in communication with the processor, and a visual display in communication with at least one of the processor and electronic storage medium. In either of the aforementioned embodiments, either of the standalone computer system or the evaluation unit 10 are configured to generate visually and/or auditory perceptible results from the use and testing of test specimens with the diagnostic device 1 as disclosed herein.

In one embodiment, the results indicator in the evaluation unit 10 may be a light or pair of lights (not shown), wherein a first light will be lit by the evaluation unit 10 when the evaluation unit determines that a threshold amount of ammonia is present between the electrodes 4, 5, which thus provides a visual indication that an infection of Helicobacter pylori bacteria is present in the tested specimen. Optionally, a second light may be lit by the evaluation unit 10 when the evaluation unit determines that a threshold amount of ammonia is not present between the electrodes 4, 5, which thus provides a visual indication that an infection of Helicobacter pylori bacteria is not present in the tested specimen. In an alternate embodiment, the indicator may be a visual display (not shown), such as a computer monitor in communication with at least one of the processor and electronic storage medium. In such a visual display, text and/or graphics may be displayed thereon to indicate the presence or absence of a threshold amount of ammonia to signify the presence or absence of a Helicobacter pylori bacteria infection in the tested tissue sample. For example, such text-based indications may include the displaying of the word(s) “Positive” or “Infection Present” on a screen to indicate that the diagnostic device 1 or evaluation unit 10 has determined a threshold amount of ammonia, and thus Helicobacter pylori bacteria, has been found to be present in a tested sample. Conversely, the displaying of the word(s) “Negative” or “No Infection Present” on a display may be used to indicate that the diagnostic device 1 or evaluation unit 10 has determined a threshold amount of ammonia, and thus Helicobacter pylori bacteria, has not been found to be present in a tested sample.

In one embodiment, the evaluation unit 10 can apply an electrical voltage “U” between the first electrode 4 and the second electrode 5 in the nutrient solution 3 for a predetermined amount of time. The evaluation unit 10 can then take a measurement of an electrical variable, for example an electric potential, electric current, or electric resistance, between the electrodes 4, 5 submerged in the nutrient solution 3, and record the value of the measured electrical variable in either of the processor or computer readable storage medium. In one embodiment, the real time measurement of the electrical variable may be concurrently displayed on a either a separate readout 11, such as for example an analog or digital readout or other similar output display in electrical communication with the evaluation unit 10, or on a visual results indicator of the evaluation unit as previously disclosed herein. When the diagnostic device 1 is in a standby-mode, such as that depicted in FIG. 2 wherein no tissue sample is present in the nutrient solution 3, a first recorded measurement of the electrical variable provides a baseline reading against which to evaluate subsequent measurements of the electrical variable when test specimens are introduced into the nutrient solution 3.

Referring to FIGS. 3 and 4, a test specimen, such as a tissue sample 6 taken from a biopsy, has been introduced into the nutrient solution 3 in the diagnostic device 1 and an active test for Helicobacter pylori bacteria is being performed. As previously disclosed herein, a voltage “U” is applied for a predetermined amount of time by the electrodes 4, 5 to the nutrient solution 3 in which the tissue sample 6 is submerged. The evaluation unit 10 is active to take a second measurement of the electrical variable, which may be stored in the evaluation unit and displayed on the readout 11. As previously disclosed herein, the Helicobacter pylori bacteria generates ammonia in the presence of an acidic environment such as the nutrient solution 3. Any ammonia generated by the Helicobacter pylori bacteria into the nutrient solution 3 will cause a continued buildup of the silver chloride (AgCl) layer on the second electrode and will change the measurement of the electrical variable that is being measured by the evaluation unit 10. After a predetermined amount of time under an applied voltage “U”, the second measurement of the electrical variable is taken and the evaluation unit 10 compares the first measurement of the electrical variable, from standby-mode, to the second reading of the electrical variable, from the active test. If the evaluation unit determines that a threshold amount of a change has occurred in the measurement of the electrical variable between the first measurement and the second measurement, this indicates a positive test for threshold amounts of ammonia being released by the test sample, which in turn provides an indication that the Helicobacter pylori bacteria is present in the tissue sample.

Referring to FIGS. 2 and 3, the analog dial readout 11 indicates that the second measurement of the electrical variable from the active test (FIG. 3) is the same as the first measurement of the electrical variable taken when the diagnostic device was in standby-mode (FIG. 2). Accordingly no noticeable change has occurred in the measurement of the electrical variable between the standby-mode and the active-test of the tissue sample 6, thus no ammonia was generated by the tissue sample upon introduction into the nutrient solution 3, and it is determined that the tissue sample 6 in FIG. 2 is not infected by the Helicobacter pylori bacteria. In this case, the evaluation unit 10 automatically compares the previously recorded reading of the first measurement of the electrical variable to the second active-test reading of the electrical variable, makes a determination that the tissue is not infected with Helicobacter pylori bacteria, and outputs to the result indicator a visual indication that no Helicobacter pylori bacteria infection is present in the tissue sample.

Referring to FIGS. 2 and 4, the analog dial readout 11 indicates that the second measurement of the electrical variable from the active test (FIG. 4) is significantly increased from the first measurement of the electrical variable taken when the diagnostic device was in standby-mode (FIG. 2). Accordingly the measurement of the electrical variable has increased in the active-test of the tissue-sample 6 past a threshold level, as compared to the measurement taken in standby-mode, thus indicating ammonia was generated by the tissue sample upon the introduction of the sample into the nutrient solution 3. The evaluation unit then may trigger the results indicator to provide an indication that the tissue sample 6 in FIG. 2 is infected by the Helicobacter pylori bacteria. In this case, the evaluation unit 10 automatically compares the previously recorded reading of the first measurement of the electrical variable to the second active-test reading of the electrical variable, makes the determination that the tissue is infected with Helicobacter pylori bacteria, and outputs to the result indicator a visual or auditory indication that Helicobacter pylori bacteria infection is present in the tissue sample.

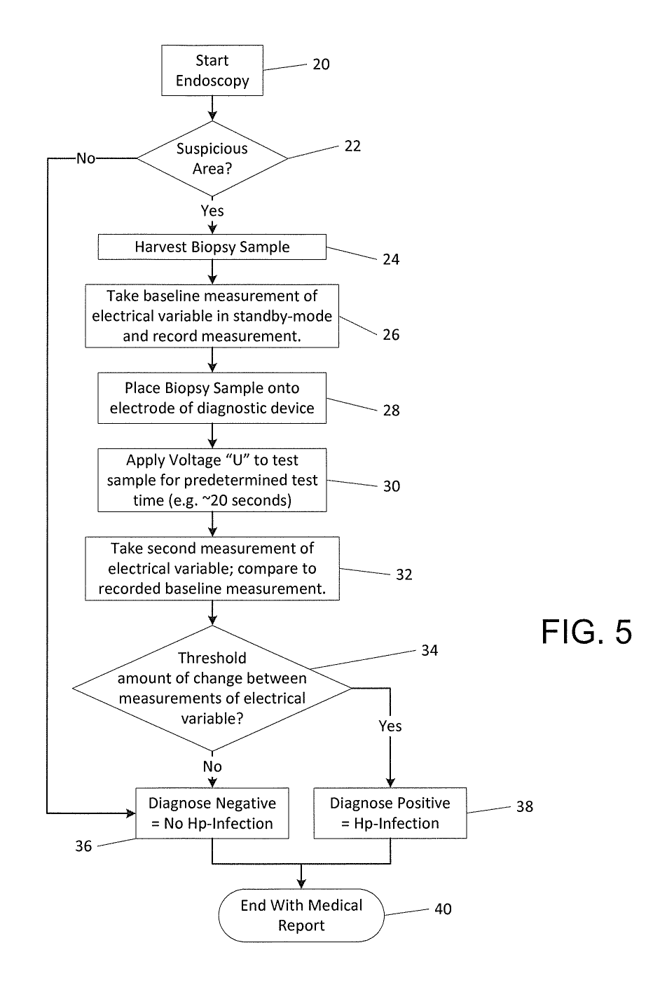

Referring to FIG. 5, a flow chart depicts an embodiment of a testing procedure or method for detecting the presence of Helicobacter pylori bacteria in a test specimen utilizing a diagnostic device as disclosed herein. In one embodiment, a medical professional performs an endoscopy procedure 20 in the gastro-intestinal tract of a test subject or patient. During the endoscopy procedure, the medical professional looks for any areas of tissue in the gastro-intestinal tract that look abnormal or suspicious 22, as compared to healthy tissue. If the medical professional does not see any tissue that looks suspicious, then the medical professional makes a negative diagnosis 36 for a Helicobacter pylori bacteria infection, and generates a medical report 40 indicating that there is no Helicobacter pylori bacteria infection present in the gastro-intestinal tract of the patient. However, if the medical professional does see a suspicious area in the patient's gastro-intestinal tract, then the medical professional harvests a biopsy sample 24 from the suspicious area of the gastro-intestinal tract. Utilizing a diagnostic device 1 as disclosed herein, the medical professional applies a voltage “U” between the electrodes of the diagnostic device, when the diagnostic device 1 is in a standby-mode with no tissue present in the diagnostic device 1, and takes a baseline first measurement of an electrical variable 26 between the electrodes. The first measurement is recorded in the evaluation unit, where it is stored for recall and later use.

Next the biopsied tissue sample is placed onto the second electrode 28 in the nutrient solution of the diagnostic device. A voltage “U” is applied between the electrodes of the diagnostic device for a predetermined amount of test time 30 (e.g. about 20 seconds) with the tissue sample submerged in the nutrient solution. In alternate embodiments, alternate amounts of test time may be utilized as necessary to properly determine whether Helicobacter pylori bacteria is present in the tissue sample being tested, without departing from the scope of the present disclosure. The evaluation unit takes a second measurement of the electrical variable (e.g. a voltage, electric potential, electric resistance, electric current, etc.) after waiting the predetermined amount of test time, and compares the first base-line measurement to the second measurement 32 to ascertain if a threshold amount of change between the two readings has occurred 34. If a threshold amount of change between the two measurements has not occurred, the evaluation unit makes a negative diagnosis 36 for the presence of a Helicobacter pylori bacteria infection. If a threshold amount of change between the two measurements has occurred, the evaluation unit makes a positive diagnosis 38 for the presence of a Helicobacter pylori bacteria infection. For either of the two diagnoses, the evaluation unit provides an indication, such as a visual or auditory indication, via the result indicator, as to the presence or absence a Helicobacter pylori bacteria infection, and generates a medical report 40 that provides the appropriate diagnosis regarding the presence or absence a Helicobacter pylori bacteria infection in the tested tissue sample.

Although modifications and changes may be suggested by those skilled in the art, it is the intention of the inventors to embody within the patent warranted heron all changes and modifications as reasonably and properly come within the scope of their contribution to the art.

What is claimed is:

1. A diagnostic device, comprising:
a first electrode made of a noble metal, which cannot be attacked by acid;
a second electrode having an electrode base made of silver and a layer of silver chloride covering said electrode base;
a container containing an acidic nutrient solution in which the first electrode and the second electrode are at least partially immersed, said container being adapted to allow introduction of a tissue sample into the acidic nutrient solution therein to expose said first and second electrodes to said acidic nutrient solution with said tissue sample therein;
a voltage source connected between said first electrode and said second electrode that produces an electric voltage across said first electrode and said second electrode in said acidic nutrient solution, with said tissue sample disposed therein, between said first and second electrodes;
an evaluation unit that detects a change in an electrical variable between said first electrode and said second electrode when ammonia is present in said acidic nutrient solution with said tissue sample disposed therein between said first electrode and said second electrode, said change resulting from said ammonia selectively attacking said silver chloride layer and exposing a portion of said base electrode made of silver; and
a results indicator in communication with said evaluation unit and configured to provide a visual indication as to the presence of a predetermined threshold amount of ammonia in said acidic nutrient solution with said tissue sample disposed therein.

2. A diagnostic device as claimed in claim 1, wherein said voltage source produces an electric voltage between said first electrode and said second electrode of zero.

3. A diagnostic device as claimed in claim 1, wherein said voltage source produces said electric voltage source as an AC voltage with a variable frequency spectrum.

4. A diagnostic device as claimed in claim 1, wherein said voltage source produces said electric voltage as a DC voltage for a predetermined period of time.

5. A diagnostic device as claimed in claim 1, wherein said detector measures electrical potential as said electrical variable.

6. A diagnostic device as claimed in claim 1, wherein said detector measures electrical current as said electrical variable.

7. A diagnostic device as claimed in claim 1, wherein said detector measures electrical resistance as said electrical variable.

8. A diagnostic device as claimed in claim 1, wherein said acidic nutrient solution is a hydrochloric nutrient solution.

9. A diagnostic device as claimed in claim 1, wherein said nutrient solution is a buffered nutrient solution.

10. A diagnostic device as claimed in claim 1, wherein said nutrient solution comprises urea.

11. A diagnostic device as claimed in claim 1, wherein said first electrode is made of a noble metal selected from the group consisting of platinum and gold.

12. A diagnostic device as claimed in claim 1, wherein said container comprises a container wall, and wherein said first electrode is integrated into said container wall.

13. A diagnostic device as claimed in claim 1, wherein said container contains a container base, and wherein said second electrode is formed by said container base.

14. A diagnostic device as claimed in claim 1, wherein at least one of said first electrode and said second electrode is configured to be replaceable.

15. A diagnostic device as claimed in claim 1, wherein said second electrode is regenerable.

16. A diagnostic device as claimed in claim 1, wherein said voltage source generates said electrical voltage as an AC sinusoidal voltage.

17. A diagnostic device as claimed in claim 1, wherein said voltage source generates said electrical voltage as an AC triangular voltage.

18. A diagnostic device as claimed in claim 1, wherein said voltage source generates said electrical voltage as an AC sawtooth voltage.

19. A diagnostic device as claimed in claim 1, wherein said voltage source generates said electrical voltage as an AC voltage representing a noise spectrum.

20. A diagnostic device as claimed in claim 1, wherein said voltage source generates said electrical voltage as an AC voltage having a variable frequency spectrum comprised of at least two pulses with respectively different shapes.

21. A diagnostic device as claimed in claim 1, wherein said voltage source generates said electrical voltage as an AC voltage with a variable frequency spectrum comprised of components having respectively different bandwidths.

22. A diagnostic device as claimed in claim 1, wherein said voltage source generates said electrical voltage as a modulated AC voltage having a variable frequency spectrum.
